(19) United States
(12) Patent Application Publication
(10) Pub. No.: US 2010/0294135 A1
(43) Pub. Date: Nov. 25, 2010

(54) Automatic French Press

(75) Inventors: Michael Weissman, Newport Beach, CA (US); Robert Radi, Bevery Hills, CA (US)

Correspondence Address: Lauson & Tarver LLP, 880 Apollo Street, SUITE 301, El Segundo, CA, 90245, US

(73) Assignee: Michael Weissman

(21) Appl. No.: 12/471,303

(22) Filed: May 22, 2009

(51) Int. Cl. A47J 31/44; A47J 31/06

(52) U.S. Cl. 99/287; 99/299

(57) ABSTRACT

An automatic steeping French press style apparatus comprises a housing and a carafe. The housing accommodates the carafe and comprises a motor and selector control for operating the device. The housing also comprises a funnel for directing liquid into the carafe, and a driving mechanism in communication with the motor for automatic control of a filter. The filter mechanism operates by virtue of a lead screw which, when rotating, urges a filter and stabilizer downward through the carafe. The non-circular columnar shape of the carafe prevents the filter and stabilizer from turning with the vertical shaft. An agitator located at the bottom of the vertical shaft is used to stir up sediment prior to filtration.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

Coffee presses are known in the art. U.S. Pat. No. 6,797,304 to McGonagle discloses a steeping apparatus for steeping solid food material in liquid, imparting a flavor to the liquid, producing a flavored beverage. A container is provided to hold the solid food material and the liquid. A plunger movable with respect to the container between a first plunger position and a second plunger position includes a filter element that, as the plunger moves from the first plunger position to the second plunger position, permits the flow of liquid but inhibits the passage of solid food material. A buffer element is selectable between a closed position and an open position. When the second plunger position and buffering position are selected, the solid material is substantially decoupled from the flavored beverage. When the buffer element is at the non-buffering position, the solid food material is not substantially decoupled from the flavored beverage.

U.S. Pat. No. 6,422,133 to Brady discloses a steeping apparatus for steeping granular solid food material in a liquid to impart flavor to the liquid, producing a flavored beverage. The apparatus includes a container to hold solid material and liquid. A plunger is movable vertically with respect to the container between an upper plunger position and lower plunger position. The plunger includes a filter element that, as the plunger is moved from the upper plunger position to the lower plunger position, permits liquid flow but inhibits solid material passage. A buffer element above the plunger is movable with respect to the container from an upper position to a lower position. When the buffer is at the lower position, the granular solid food material is substantially decoupled from the flavored beverage.

Neither of these references are automatic, nor are they capable of stirring container bottom sediment.

U.S. Pat. No. 7,040,218 to Biolchini, Jr. discloses a stirring coffee press for brewing beverages, such as coffee or tea, and simultaneously compressing and agitating unfiltered liquid in a single container. The stirring coffee press includes a container with a fitted lid, a plunger attached to a hollow shaft slidably and rotatably received within the container and extending through a lid opening. A blade assembly attaches to a shaft extending and exiting through the hollow shaft of the plunger assembly. The hollow shaft has a handle adapted to be received and retained in the lid aperture, thereby preventing the plunger assembly from rotating. The blade assembly shaft has a knob attached to its open end allowing the blade assembly to freely rotate.

International patent application 2008/044948 to Hunter discloses a French press device comprising a plunger equipped with a stirring apparatus beneath the plunger for stirring the contents of a carafe. The stirrer is rotated on a single rod passing through the plunger/filter. An isolating connection allows the stirrer to be rotated by twisting the knob on the rod above the lid while the plunger/filter remains still, held by the friction of the plunger/filter apparatus pushing against the side of the container.

While these devices are capable of a combination French press/stirring action, they cannot operate automatically.

U.S. Pat. No. 6,240,833 to Sham, et al. discloses an automatic French press beverage maker incorporating an automatic hot water dispensing machine having a housing, a water tank and electric water heater. The dispensing machine is adapted to communicate with a French press plunger/strainer extractor that also functions as a serving carafe for hot infused beverages such as coffee and tea.

While this invention discloses automatic water heating, it cannot press or stir automatically.

Therefore it is an object of the present invention to provide an automatic French press comprising automatic filtration and stirring capabilities. A further object of the invention is to provide a French press with a time delay that allows material in the carafe to steep for a predetermined time prior to filtration. A further object of the invention is to provide a French press with a motor driven filter assembly that automatically urges a filter through liquid. A further object is to provide a stabilizing mechanism to stabilize the filter while driving it through the carafe. A further object of the invention is to provide an agitating mechanism for stirring up sediment from the bottom of the carafe prior to filtration. These and other objects will become apparent from the following summary, description and claims.

### SUMMARY

The device of the present invention comprises top and bottom sections in hinged communication. The bottom comprises a carafe supporting base, and the top comprises a handle, funnel, and control buttons. After coffee grounds are introduced into the carafe and the carafe placed on the base, liquid of a temperature determined by the user is introduced into the funnel and a control button is selected activating a delay timer. At a predetermined time, a motor in the top operates to agitate and filter the liquid in the carafe.

The underside of the top comprises a liquid spout extending to the carafe mouth and connected to the funnel, and a drive mechanism in communication with the motor for driving the filter assembly. The filter assembly comprises a threaded vertical member, or lead screw, disposed centrally in the carafe with a filter and stabilizer disposed at the top. When the device is in operation, the drive mechanism causes the lead screw to rotate, urging the filter and stabilizer down along the vertical member. In alternate embodiments, a ball screw, worm drive, rack and pinion, fluid power or electromagnetic power may be used in lieu of a lead screw.

The interior of the carafe accommodates the threaded vertical member, filter, stabilizer and agitator. The agitator disposed at the bottom of the threaded vertical member in a preferred embodiment. The agitator comprises vanes to stir sediment at the carafe bottom. A mechanism to hold the bottom of the vertical member or in the alternate the agitator is disposed at the bottom of the carafe is provided.

The threads of the vertical member, filter and stabilizer are complimentary so that when the vertical member rotates, the filter and stabilizer are driven downward along the interior of the carafe. Since the carafe is not circular in plan view, the filter and stabilizer are unable to rotate along with the vertical member. Because the agitator is smaller in circumference than the narrowest part of the carafe, it rotates freely.

In one preferred embodiment, the threads of the vertical member, filter and stabilizer allow the vertical member to turn in one direction to rotate the agitator, while keeping the filter and stabilizer at the top of the vertical member. When the threaded member turns in the opposite direction, it urges the filter and stabilizer downward along the threaded vertical member.

### BRIEF DESCRIPTION OF THE FIGURES

FIG. 1 is a front perspective view of the automatic French press.

FIG. 2 is a side perspective view of the automatic French press.

FIG. 3 is a front perspective view of the automatic French press with the top raised.

FIG. 4 is a perspective exploded view of the carafe and handle of the automatic French press.

### DESCRIPTION

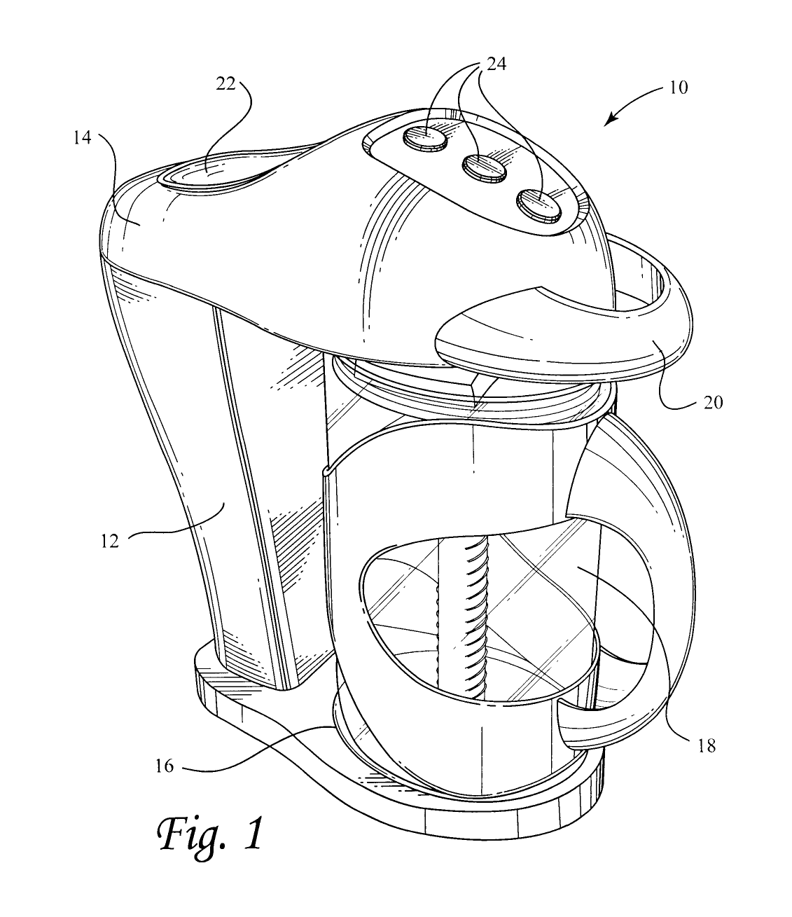

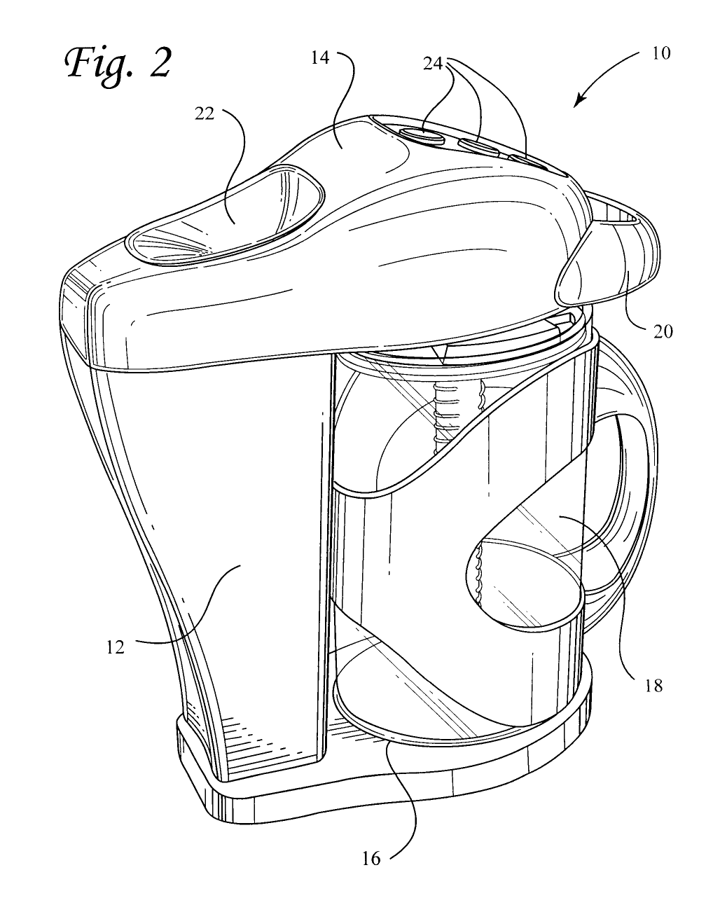

Referring to FIGS. 1 and 2, the device 10 comprises a bottom 12 and a top 14. The bottom 12 further comprises a base 16 for supporting a carafe 18. The top 14 comprises a handle 20, funnel 22, and control buttons 24, and is in hinged communication with the bottom 12. After material is deposited in the carafe 18 and the carafe 18 is placed on the base 16, boiling water or other liquid is introduced through the funnel 22 which directs it into the carafe 18. When a predetermined amount of liquid has been introduced, one or more control buttons 24 are selected. The control buttons 24 activate a delay timer allowing material to steep in the liquid for a predetermined time. Following the predetermined steeping time, a motor (not shown) inside the top 14 operates an agitating and filtering mechanism associated with the carafe 18.

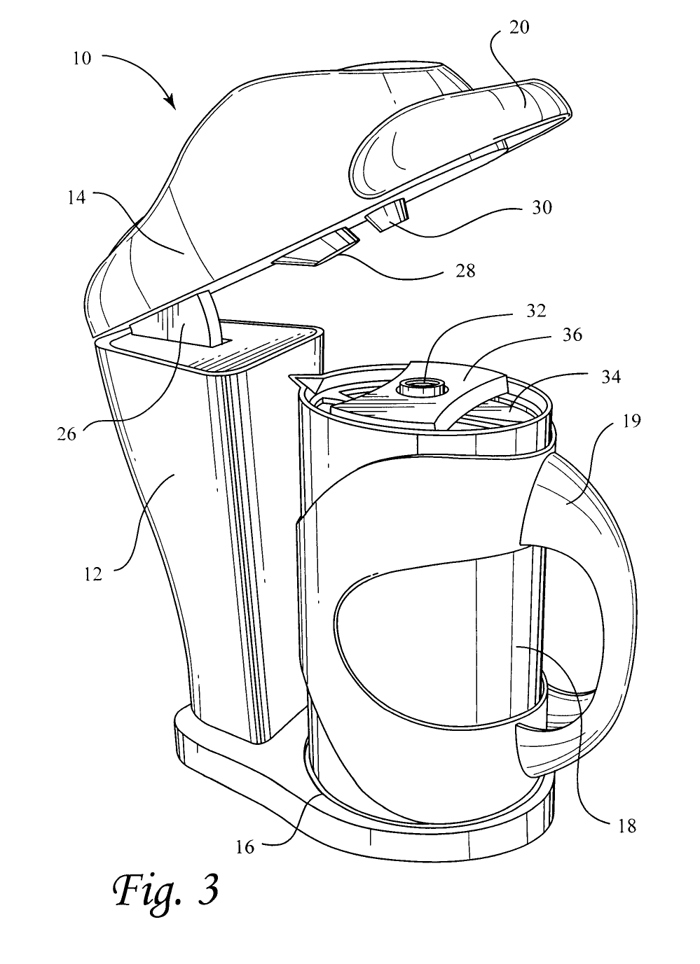

Referring to FIG. 3, the underside of the top 14 comprises a hinge 26 for anchoring the top 14 to the bottom 12, and allows a user to swing the top 14 upward using the handle 20. The underside of the top 14 further comprises a boiling water spout 28 at the bottom of the funnel (not shown) to direct boiling water into the carafe 18, and a drive mechanism 30 for driving a filter assembly.

Still referring to FIG. 3, the filter assembly comprises a threaded vertical member 32 disposed centrally in the carafe 18. A filter 34 and stabilizer 36 are disposed at the top of the vertical threaded member 32 prior to activation. In one preferred embodiment, the filter 34 and stabilizer 36 comprise a single unit. When the device 10 is in operation, the drive mechanism 30 causes the vertical member 32 to rotate, urging the filter 34 and stabilizer 36 downward along the vertical member 32. In a further preferred embodiment, the carafe 18 comprises a handle 19.

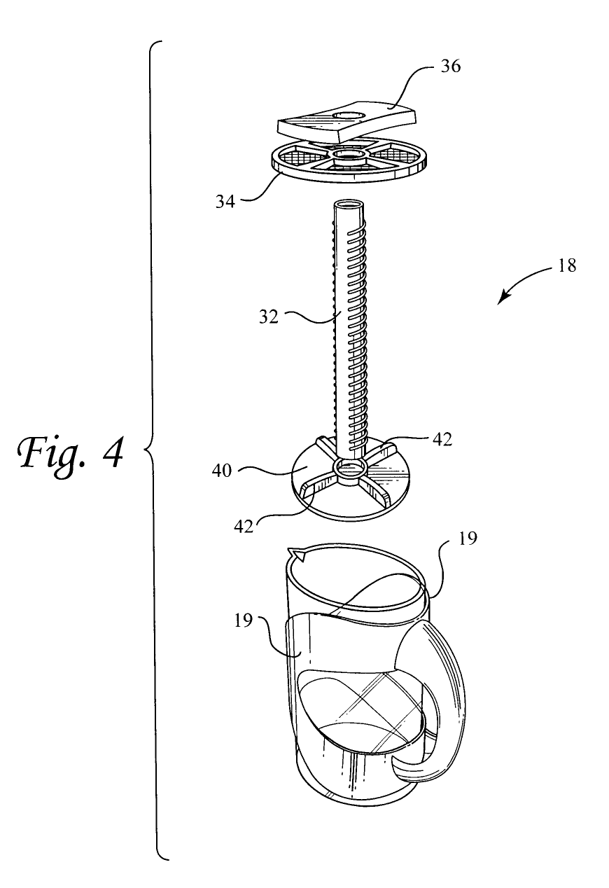

Referring to FIG. 4, the carafe 18 and its associated parts are shown and described. The interior of the carafe 18 accommodates the threaded vertical member 32, filter 34 and stabilizer 36. In a preferred embodiment, an agitator 40 is disposed at the bottom of the threaded vertical member 32. The agitator 40 comprises vanes 42, or similar structures for stirring sediment in the bottom of the carafe 18.

In order to secure the threaded vertical member 32 in place as it rotates, a mechanism 38 for holding the bottom of the threaded vertical member 32 in place is disposed at the bottom of the carafe 18. In one preferred embodiment the mechanism 38 comprises a dimple corresponding to a complimentary form at the bottom of the vertical member 32 or agitator 40. In another embodiment, the lower end of the vertical member is chamfered, enabling it to push through the material to be steeped and connect with the holding mechanism

The threads of the vertical member 32, filter 34 and stabilizer 36 are complimentary, so that when the threaded vertical member 32 rotates, the filter 34 and stabilizer 36 are driven downward along the interior of the carafe 18. Since the carafe 18 is not circular in plan view, the filter 34 and stabilizer 36 cannot rotate along with the threaded vertical member 32. The agitator 40 is smaller in circumference than the narrowest part of the carafe permitting it to rotate freely.

In one preferred embodiment, the threads of the threaded vertical member 32, and the filter 34 and stabilizer 36 are designed to allow the vertical threaded member to turn in one direction, spinning the agitator, while keeping the filter 34 and stabilizer 36 at the top of the vertical threaded member 32. When the threaded member turns in the opposite direction, the filter 34 and stabilizer 36 are urged downward along the threaded vertical member 32.

The structure of the invention having been shown and described, operation of the invention is now described.

In order to use the automatic French press, a material to be steeped, including coffee grounds or tea, is introduced into the carafe. Thereafter the threaded vertical member bearing the filter, stabilizer and agitator is introduced. The bottom of the threaded member agitator assembly is disposed on the anchor mechanism at the center of the bottom of the carafe. In an alternate method, the vertical member and agitator are set in place prior to the introduction of material into the carafe. The filter and stabilizer are positioned thereafter.

With the carafe prepared, the top of the device is lifted, and the carafe and filter assembly placed on the base of the device. Lowering the top engages the drive mechanism and vertical member, and positions the boiling water entry to direct liquid into the carafe.

Boiling water is introduced into the funnel, directing it into the carafe to mingle with the material to be steeped. A control button is selected to determine the desired steeping time. The control buttons activate a timer causing a predetermined time delay prior to motor activation. At the end of the predetermined delay time, the motor causes the vertical member to spin in one direction so that the threads of the vertical member do not engage the complimentary threads on the filter and stabilizer assembly. In this manner, the device causes the agitator to spin, stirring up sediment at the bottom of the carafe.

After a second predetermined time, the motor reverses direction, causing the threads on the vertical member to engage the threads on the filter and stabilizer assembly, thereby urging the filter and stabilizer downward along the vertical member and filtering the material in the carafe. The filter and stabilizer are prevented from rotating with the vertical member by virtue of the non-circular carafe shape. The agitator is able to rotate freely since its diameter is smaller than the narrowest point of the carafe. Once the filter and stabilizer have been driven to the bottom of the carafe, the carafe can be removed from the device, and a brewed beverage decanted from the carafe. Optionally, the agitator may spin in a single, filter-driving direction.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A beverage making device comprising:
a. a vessel with an interior having an inside wall, a closed bottom and an opening at the top;
b. at least one filter element permitting liquid flow-through but substantially inhibiting the passage of solid material;
c. at least one actuating member in communication with the filter; and
d. wherein the actuating member urges the filter from the vessel top to the vessel bottom, filtering the contents of the vessel.

2. The device of claim 1, wherein the at least one actuating member employs, as a means of urging the filter, a mechanism chosen from the list comprising: lead screw, ball screw, worm drive, rack and pinion, fluid power, and electromagnetic actuation.

3. The device of claim 1, wherein the actuating member is in communication with a motor.

4. The device of claim 1, including a stabilizer in communication with the filter.

5. The device of claim 4, wherein the actuating member drives the filter and stabilizer in tandem.

6. The device of claim 5, wherein the actuating member engages in a first movement that allows the filter and stabilizer to remain at the top of the vessel, and a second movement that urges the filter and stabilizer toward the bottom of the vessel.

7. The device of claim 1, wherein an agitator is associated with the actuating member.

8. The device of claim 7, wherein the agitator attaches to the actuating member at the bottom of the vessel.

9. The device of claim 1, wherein a motor engages the actuating member and causes the actuating member to urge the filter.

10. The device of claim 1, wherein the bottom of the vessel comprises an attachment point for maintaining the actuating member in position at the bottom of the vessel.

11. The device of claim 1, comprising a selector for selecting one or more predetermined time delays, after which the actuating member urges the filtering means and stabilizing means.

12. The device of claim 11, wherein the selector comprises buttons disposed at the top of the device.

13. The device of claim 7, wherein the agitator comprises vanes for agitating liquid in the vessel.

14. The device of claim 1, wherein the top of the device comprises a funnel that accepts liquid and directs it into the vessel.

15. The device of claim 4, wherein the filter and stabilizer comprise a single unit.

16. The device of claim 1, wherein the vessel shape prevents the filter from rotating relative to the vessel when urged through the vessel.

17. A beverage making device comprising:
a. a holder with a hinged top and bottom, capable of accommodating a carafe
b. at least one carafe, non-circular in plan view with at least one interior side wall.
c. a filtering mechanism comprising at least one lead screw, a filter and stabilizer, wherein the lead screw engages a motor in the top of the holder, and the lead screw urges the filter and stabilizer in a lateral direction in the carafe when the lead screw rotates, while the filter maintains contact with the carafe's at least one side wall.

18. The device of claim 17, wherein the lead screw further comprises an agitator disposed at the bottom of the threaded rod.

19. The device of claim 17, wherein the holder top comprises a funnel oriented to direct liquid into the carafe.

20. The device of claim 17, wherein the holder top comprises a selector for causing a delay between the time a liquid is added to the device, and the time the motor drives the lead screw.

21. The device of claim 17, wherein in lieu of a lead screw, a mechanism chosen from the list of: ball screw, worm drive, rack and pinion, fluid power, and electromagnetic actuator is used.

22. The device of claim 1, wherein the filter comprises an outer circumference in frictional contact with the inside vessel wall.
